(19) United States
(12) Patent Application Publication
(10) Pub. No.: US 2006/0240886 A1
(43) Pub. Date: Oct. 26, 2006

(54) Omnipotent Opponent

(76) Inventor: Scott Lawrence Patten, MARINA, CA (US)

Correspondence Address: SCOTT L. PATTEN, 183 A PADDON PLACE, MARINA, CA, 93933, US

(21) Appl. No.: 10/907,915

(22) Filed: Apr. 20, 2005

(51) Int. Cl. G06F 17/00

(52) U.S. Cl. 463/14

(57) ABSTRACT

Traditionally, a computer chess program will take the current state of the board (the position of the pieces in play) and using a database of moves, it will select what it feels is the best move. This is how every computer chess program works. The Omnipotent Opponent uses an entirely different approach. In a game of chess there is a finite sized board (8×8 squares), and finite number of pieces (16 black and 16 white). At any given time only a finite number of pieces can move and they can only move in a finite number of directions. Therefore, it is possible to plot every single move that could ever be made in a game of chess and every resulting outcome of the game. Once this data has been generated, it could be analyzed in reverse (working from the end game to the start) and each phase of the game could be marked with the best move. Using this best move data, one would always know the best move to make at any point in any chess game. Equipped with this information, one would never loose. Not because they are able to plan moves ahead in the game, but rather because they already know exactly what the outcome of every move could ever be. This system is not confined to the game of chess. It can be used with any game as long as the game can be properly analyzed. Other examples are checkers and tic-tac-toe. With all the games, the procedure involves the same three steps: First, plot every possible move to the end of the game. Second, analyze the results starting at the end, and mark the best moves. Third, use the ‘best move’ data. Obviously this system does not work for every game. The two factors that will prevent this system from working with a game are: First, Any game involving chance. A game cannot be plotted if it involves dice, face down cards, flipping a coin, or any other random outcome. Second, it cannot contain any infinite variables. A game cannot be plotted if it involves an unlimited number of pieces.

Description

This computer system can play a perfect game of checkers, chess, or other specific type game.

What is claimed is:

1. This computer system will know every possible move in a game and its outcome. With this information, it can deduce the most effective move at any time of a game. When used from the beginning of a game, the system will be able to play a ‘perfect’ game. This only works with a specific type of game: The game must have a playing area with finite dimensions as well as a finite number of pieces and moves. Also there must be no chance involved in the game (no dice).
